(19) United States
(12) Patent Application Publication
(10) Pub. No.: US 2010/0275506 A1
(43) Pub. Date: Nov. 4, 2010

(54) Use of high-intensity light to immobilize and enable removal or capture of insects

(76) Inventor: Kevin T. Kavanagh, (US)

Correspondence Address: Kevin T Kavanagh, 3396 Woodhaven Dr, Somserset, KY, 42503, US

(21) Appl. No.: 12/434,656

(22) Filed: May 3, 2009

(51) Int. Cl. A01M 3/02

(52) U.S. Cl. 43/137; 43/113

(57) ABSTRACT

The process of killing an insect by first blinding it with high-intensity light then extirpate, capture or remove the insect by mechanical means. For example: Flies are hard to kill because of their keen sense of vision which enables them to easily evade a flyswatter. Using a flash (similar to a flash on a camera) or a laser (harder to aim but will produce the same results) immobilizes a fly and allows it to be hit with a fly swatter. This process can be easily tested with a camera and a fly swatter. A product called a “Flash Swatter” can be easily made which combines a fly swatter and a camera's flash (located on the swatter's lower shaft).

A patent for the process of blinding an insect with bright light to allow its removal, capture or extirpation. A product called a “Flash Swatter” can be easily made which combines a fly swatter and a camera's flash (located on the swatter's lower shaft).

### BACKGROUND OF INVENTION

The inventor notices that a fly will evade swatting as soon as a fly swatter approaches it. The fly also has very large eyes. The inventor was blinded by a camera flash and wondered if the same would happen to the fly. Using a bright flash of light, the inventor blinded the fly which allowed easy swatting.

What is claimed:

1. The inventor is claiming the two-step process of:
Step #1: Using a bright light to blind and immobilize an insect.
Step #2: To mechanical kill, extirpate, remove or capture the insect.
